(19) United States
(12) Patent Application Publication
(10) Pub. No.: US 2010/0169013 A1
(43) Pub. Date: Jul. 1, 2010

(54) VEHICLE POSITIONING DEVICE

(75) Inventors: Motohiro Nakamura, Aichi (JP); Hidenobu Suzuki, Ann Arbor, MI (US); Masaki Nakamura, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: TOYOTA JIDOSHA KABUSHIKI KAISHA, Toyota-shi, Aichi (JP); AISIN AW CO., LTD., Anjyo-shi, Aichi (JP)

(21) Appl. No.: 12/066,774

(22) PCT Filed: May 15, 2007
(86) PCT No.: PCT/JP2007/059980

§ 371 Date: Mar. 13, 2008

(30) Foreign Application Priority Data
May 29, 2006 (JP) 2006-148683

(51) Int. Cl. G01C 21/26

(52) U.S. Cl. 701/213; 701/200

(57) ABSTRACT

Setting a planimetric feature having a high frequency of appearance as a planimetric feature to be recognized necessary for an own-vehicle position correction by referring to arrangement patterns of planimetric features having a high frequency of appearance for each of a plurality of types of road in response to a target object for an assist control, for example, a characteristic planimetric feature in an area where the own-vehicle will travel hereafter from among planimetric features on a road of which information is stored in a map database. Then, recognizing the set planimetric feature, and correcting an own-vehicle position from one based on a GPS and a travel path in accordance with a recognition result thereof.

### TECHNICAL FIELD

The present invention relates to own-vehicle position measuring apparatuses and, more particularly, to an own-vehicle position measuring apparatus for correcting an own-vehicle position detected by a predetermined method based on a recognition result of planimetric feature on a road.

### TECHNICAL FIELD

Conventionally, there is known an apparatus that acquires a correlation by comparing a vehicle travel path, which is computed based on signals from an azimuth sensor and a travel distance sensor, with a road pattern of map data stored in a map database so as to correct an own-vehicle position on a road which the both approximate (for example, refer to Patent Document 1). In this apparatus, a correction of an own-vehicle position is carried out at a timing at which a travel path characteristic to vehicles such as left or right turning at an intersection or a curve running.

Patent Document 1: Japanese Laid-Open Patent Application No. 8-61968

### DISCLOSURE OF THE INVENTION

### Problems to be Solved by the Invention

However, in the above-mentioned conventional apparatus, since an own-vehicle position is corrected only when a travel path characteristic to a vehicle is acquired and the correction of the own-vehicle is not performed in other cases (for example, straight line running), there can be a situation where an accuracy of the own-vehicle position cannot be maintained. In this regard, there may be a possibility that a control for automatically stopping a vehicle at a stop line or a crossing place or the like is not performed properly.

On the other hand, it is considered to recognize, for example, a stop line or a crosswalk, an arrow, a turn prohibition, a diamond-shaped sign indicating a presence of a crosswalk, a traffic indication or a character string such as a maximum speed, a speed reducing zone, a no-stopping zone, etc., as a planimetric feature on a road which is necessary for correcting an own-vehicle position so as to correct the own-vehicle position using the recognition results. In such a system, if the planimetric feature appearing sequentially during vehicle running is recognized at each time, it is possible to correct the own-vehicle position relatively frequently, and, thus, the own-vehicle position measured can be always maintained with high accuracy. However, since there are many cases where the planimetric features on a road appear consecutively, a processing load may be increased in the above-mentioned method of recognizing the planimetiric features appearing sequentially.

The present invention was made in consideration of the above-mentioned point and aims to provide an own-vehicle position measuring apparatus that is capable of reducing a processing load of planimetric feature recognition while maintaining an accuracy of an own-vehicle position at a certain high level.

### Means to Solve the Problems

The above-mentioned object can be achieved by an own-vehicle measuring apparatus comprising: planimetric feature recognizing means for recognizing a planimetric feature on a road that is necessary for correcting an own-vehicle position; and position correcting means for correcting the own-vehicle position detected according to a predetermined method based on a recognition result by said planimetric feature recognizing means, the own-vehicle measuring apparatus further comprising recognizing planimetric feature setting means for setting a planimetric feature characteristic in an area where the own-vehicle will travel hereafter from among planimetric features on the road of which information is stored in a database, wherein said planimetric feature recognizing means recognizes said planimetric feature set by said recognizing planimetric feature setting means.

In this mode of invention, a characteristic planimetric feature in the area where the own-vehicle will travel hereafter from among planimetric features on a road is set as a planimetric feature to be recognized and necessary for correcting the own-vehicle position. Then, the set planimetric feature is recognized, and the own-vehicle position is corrected based on the recognized planimetric feature. According to the structure, a process load of the planimetric feature recognition can be reduced while maintaining accuracy of the own-vehicle position at a certain high level since only the characteristic planimetric feature from among all planimetric features in the area where the own-vehicle will travel hereafter becomes an object for the own-vehicle position correction.

It should be noted that a certain level of regularity is recognized in patterns of arrangement of planimetric features in accordance with kinds of a road where a vehicle will travel hereafter (for example, a large-scale intersection where many lanes exist and roads cross with each other intricately, a normal intersection where national roads or prefectural roads having more than two lanes cross with each other, a two-way traffic curved road having one lane on each side and having a small radius of curvature, an intersection having a stop line along a narrow street, etc.). Accordingly, the planimetric feature to be recognized is limited to a part thereof if the planimetric feature to be recognized if it is set by referring to arrangement patterns of planimetric features corresponding to kinds of roads, and the process load of the planimetric recognition can be reduced.

Accordingly, in the above-mentioned own-vehicle position measuring apparatus, said recognizing planimetric feature setting means may set a planimetric feature, which is estimated to appear in the area where the own-vehicle will travel hereafter by referring to a predetermined arrangement pattern of the planimetric feature according to a kind of a road on which the own-vehicle will travel hereafter, as said planimetric feature to be recognized by said planimetric feature recognizing means.

Additionally, a planimetric feature of a kind in which a characteristic hardly appear (for example, a stop line) requires a large process load when performing a recognition thereof, on the other hand, a planimetric feature of a kind in which a characteristic tends to appear (for example, a crosswalk or a diamond-shaped indication indicating presence of a crosswalk) does not require a large process load when performing a recognition thereof. Accordingly, in the own-vehicle position measuring apparatus, said recognizing planimetric feature setting means may set a planimetric feature of a kind in which a characteristic thereof tends to appear in the area where the own-vehicle will travel hereafter as said planimetric feature to be recognized by said planimetric feature recognizing means.

Additionally, there may be a case where the planimetric feature of a kind in which a road indication tends to be scraped (for example, a crosswalk) cannot be recognized due to the scrape even when the recognition process is performed, on the other hand, there is little possibility that a recognition incapability occurs due to the scrape. Accordingly, in the above-mentioned own-vehicle position measuring apparatus, said recognizing planimetric feature setting means may set a planimetric feature of a kind in which a road-surface sign is hardly scraped in the area where the own-vehicle will travel hereafter as said planimetric feature to be recognized by said planimetric feature recognizing means.

Further, there is little possibility that a planimetric feature having a relatively long distance from other planimetric features existing ahead and behind is erroneously recognized as other planimetric features when recognizing thereof, and there is little possibility that a position is erroneously detected. Accordingly, in the above-mentioned own-vehicle position measuring apparatus, said recognizing planimetric feature setting means may set a planimetric feature having a distance from a planimetric feature positioned ahead or behind longer than a predetermined distance in the area where the own-vehicle will travel hereafter as said planimetric feature to be recognized by said planimetric feature recognizing means.

It should be noted that in the above-mentioned own-vehicle position measuring apparatus, said planimetric feature recognizing means may recognize a planimetric feature on the road based on an image taken by image-taking means for taking images around a vehicle. Additionally, said predetermined method may be a method of detecting an own-vehicle position by using a GPS or a travel path of the own vehicle.

### EFFECT OF THE INVENTION

According to the present invention, a process load of planimetric feature recognition can be reduced while maintaining accuracy of the own-vehicle position at a certain high level.

### BRIEF DESCRIPTION OF THE DRAWINGS

FIG. 1 is a structural diagram of a system mounted to a vehicle, which is an embodiment of the present invention.

FIG. 2 is an illustration expressing indications of planimetric features of each type.

FIG. 3 is a flowchart of an example of a main routine performed in the system of the present invention.

FIG. 4 is a flowchart of an example of a subroutine performed in the system of the present embodiment.

FIG. 5 is a table representing an example of priority levels of types of planimetric features and permission and negation of setting thereof when setting a planimetric feature to be recognized necessary for correcting an own-vehicle position in a certain specific area.

### EXPLANATION OF REFERENCE NUMERALS

12 position-measuring part
24 estimation navigation part
26 map-matching part
30 map database
32 back camera
34 external-world recognition part

### BEST MODE FOR CARRYING OUT THE INVENTION

A description will be given below of a preferred embodiment of the present invention.

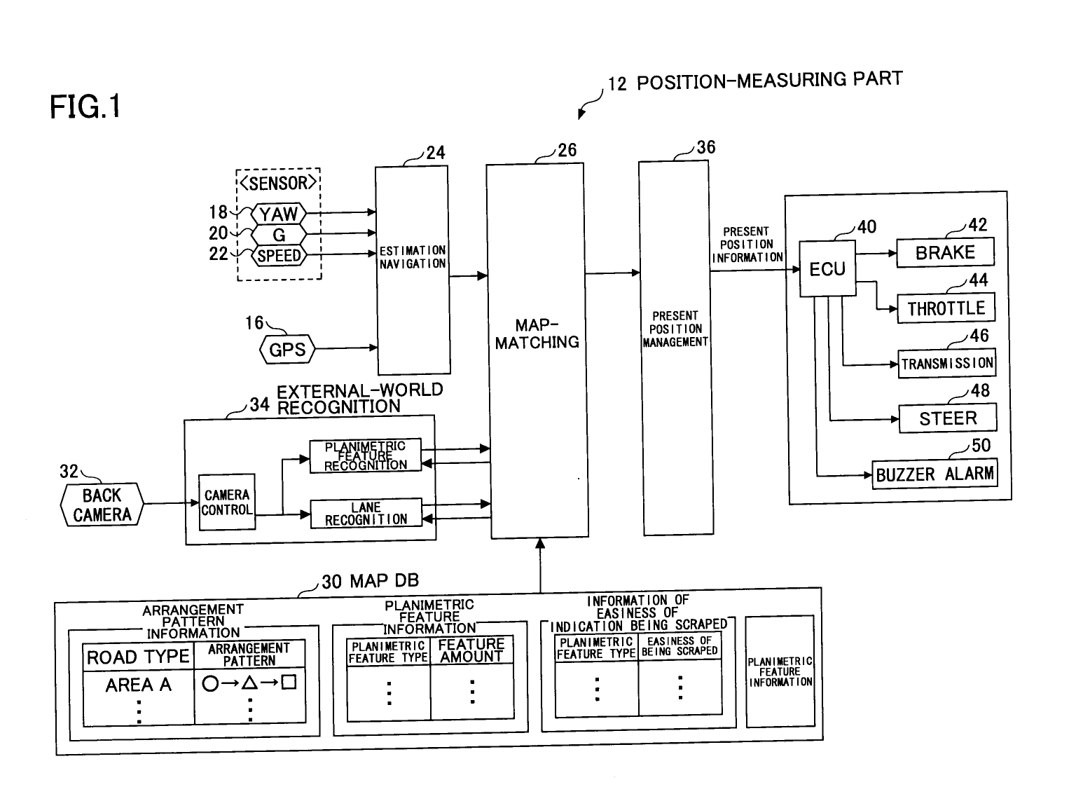

FIG. 1 shows a structural diagram of a system mounted to a vehicle, which is an embodiment of the present invention. As shown in FIG. 1, the system of the present embodiment comprises a position-measuring part 12 for positioning an own-vehicle and an assist control part 14 for controlling travel of the own-vehicle, and is a system that performs a predetermined assist control to cause the own-vehicle to travel in accordance with the position of the own-vehicle measured by the position-measuring part 12.

The position-measuring part 12 comprises a GPS receiver 16 detecting a latitude and a longitude of a position where the own-vehicle is present by receiving a GPS signal sent from a GPS (Global Positioning System) satellite, an orientation sensor 18 detecting a yaw angle (orientation) of the own-vehicle by using a turning angle and the earth magnetism, a G sensor 20 detecting an acceleration, a vehicle-speed sensor 22 detecting a vehicle speed, and an estimation navigation part 24 configured mainly by a microcomputer to which outputs of the receiver and sensors 16 to 22 are connected. The output signals of the receiver and sensors 16 to 22 are supplied to the estimation navigation part 24. The estimation navigation part 24 detects a latitude and a longitude (initial coordinate) of the position of the own-vehicle based on information from the GPS receiver 16, and detects a traveling state of a traveling direction, a vehicle speed and acceleration and deceleration of the own-vehicle based on the sensors 18 to 22 so as to create a travel path (estimated path) of the vehicle from the initial coordinate of the own-vehicle position.

The positioning part 12 also comprises a map-matching part 26 mainly configured by a microcomputer connected to the estimation navigation part 24, and comprises a map database 30 connected to the map-matching part 26. The map database 30 is configured by a hard disk (HDD), a DVD or a CD mounted on the vehicle or provided in a center, and stores link data of roads themselves necessary for route guide or map indication and position information of planimetric features or lanes drawn or installed on the roads.

Specifically, stored in the map database 30 are data of lane configurations or road types such as a latitude and longitude representing a road, a curvature, a slope, a number of lanes, a width of a lane, existence or nonexistence of a corner, etc., information regarding each intersection or node point, information regarding buildings for performing map indication, and also stores configuration data or paint data, position data, a size of feature amount, a distance data from other planimetric features ahead or behind, data indicating tendency of being scraped, a distance data from an object which is a target in a vehicle traveling direction. Additionally, the map database 30 is capable of updating stored map data to new one by exchanging the disc or establishment of an update condition.

The map-matching part 26 is supplied with information of an initial coordinate of the own-vehicle position and estimated path from the initial coordinate detected and created in the estimation navigation part 24. The map-matching part 26 has a function to perform map-matching (first map-matching) for correcting a present position of the own-vehicle onto a road by using link information of the road itself stored in the map database 30 each time the information of the estimated path is supplied from the estimation navigation part 24.

Based on the result of the first map-matching (that is, the detected own-vehicle position), the map-matching part 26 has a function to read out from the map database 30 map data on a road surface where the own-vehicle will travel within a predetermined period of time or a predetermined distance hereafter. Additionally, the map-matching part 26 sets a part of the planimetric features from among all planimetric features in a predetermined road range from the detected own-vehicle position as a planimetric feature to be recognized as mentioned later. Then, after the setting, the map-matching part 26 determines whether the recognition of the set planimetric features using a back camera image is in a situation where it should require an external-world recognition part mentioned later, and if a positive determination is made, it requires the external-world recognition part the planimetric feature recognition using the back camera image and simultaneously provides feature data such as configuration data and position data of the planimetric features, configuration data of a traveling lane and the like.

The position-measuring part 12 also comprises a back camera 32 provided at a vehicle rear bumper or the like, and an external-world recognition part 34 mainly configured by a microcomputer connected to the back camera 32. The back camera 32 has a function to take an image of an external world of a predetermined area containing a road surface behind the vehicle from the installed position, and supplies the taken image to the external-world recognition part 34. In the case where a request for image recognition using the back camera 32 is received from the map-matching part 26, a camera control part of the external-world recognition part 34 extracts a planimetric feature, a traveling lane or the line drawn on the road surface by performing image processing such as edge extraction with respect to the image taken by the back camera 32, and grasps a relative position relationship between those planimetric features and the own-vehicle. It should be noted that when extracting the planimetric feature and the traveling lane, based on the feature data such as planimetric features provided from the map-matching part 26, an area where the planimetric features or the like exist is grasped beforehand and image processing is performed on all images taken by the back camera 32 by selectively narrowing down the existing area. This is because it is efficient and effective when performing the extraction of a planimetric feature or the like from the image taken by the back camera 32.

The result of the extraction by the external-world recognition part 34 (information including the relative relationship with the planimetric features or the traveling lane) is supplied to the above-mentioned map-matching part 26. The map-matching part 26 has a function to compute a position of the own lane on the road where the own-vehicle is currently traveling based on the result of the extraction of the traveling lane supplied by the external-world recognition part 34 after requesting the image recognition using the back camera 32. Additionally, it has a function to measure a distance from the own-vehicle to the recognized planimetric feature present on the road behind the own-vehicle and a relative position of the recognized planimetric feature based on the extraction result of the planimetric feature supplied from the external-world recognition part 34 after requesting the image recognition using the back camera 32 and also perform a map-matching (second map-matching) for correcting the present position of the own-vehicle to a position having a relative relationship with respect to the recognized planimetric feature based on the measured relative positions of the own-vehicle and the recognized planimetric feature and position data of the recognized planimetric feature stored in the map database 30.

As mentioned above, the map-matching part 26 performs the first map-matching for correcting the present position of the own-vehicle onto the road link stored in the map database 30 each time the information of the estimated pat is supplied from the estimation navigation part 24, and further performs the second map-matching for correcting own-vehicle position in a forward or rearward direction or a left or a right direction in a width of the vehicle to a position based on the recognized planimetric feature when it received the supply of the extraction result of the recognized planimetric feature from the external-world recognition part 34 according to the request.

After performing the above-mentioned second map matching, the map-matching part 26 also has a function to compute a distance (hereinafter, referred to as a following remaining distance) from the own-vehicle to the target object ahead in the traveling direction along a center line of the traveling lane based on the measured own-vehicle position and the position of the traveling lane of the own-vehicle and the position of the target object stored in the database 30 each time the information of the estimated path is supplied from the estimation navigation part 24 and the own-vehicle position is updated, after the target object (for example, a stop line, an intersection, a curve entrance, etc.), which is a control object necessary for performing an assist control in front of the predetermined range in a traveling direction of the own-vehicle by cross-checking the position of the own-vehicle measured by the map-matching with the map data stored in the map database 30.

The position-measuring part 12 also has a present position management part 36 connected to the map-matching part 26. The present position management part 36 is supplied with information of a link ID and a link coordinate of the present position of the own-vehicle acquired as a result of the map-matching computed in the map-matching part 26, information of the following remaining distance, and information of the position of the traveling lane on the road where the own-vehicle is currently traveling, together with information of a time at which each information was obtained.

The present position management part 36 detects the present position of the measured own-vehicle position and the following remaining distance to the target object based on the information supplied from the map-matching part 26. The information of the present position of the own-vehicle and the following remaining distance detected by the present position management part 36 is supplied to a navigation apparatus which the own-vehicle has, and is displayed illustratively on a map displayed on the display and supplied to the above-mentioned assist control part 14.

The assist control part 14 has an electronic control unit (ECU) 40 mainly configured by a microcomputer, and performs an assist control to a driver when driving the own-vehicle on a road by the ECU 40. Specifically, the assist control includes a stop control which is a drive assist control for causing the own-vehicle at a stop line or a crossing place that are planimetric features when a braking operation by a driver is not performed, an intersection control which is a drive assist control for preventing the own-vehicle from interfering with other vehicles which is expected to meet at an intersection which is a planimetric feature on a road, a speed control for causing the own-vehicle to move at a speed appropriate to a curve (corner) which is a planimetric feature, a guide control for performing route guide by a voice sound with respect to a relative distance to the target object etc., that are performed in accordance with the above-mentioned following remaining distance from the own-vehicle to the target object in response to the position of the own-vehicle.

The ECU 40 is connected with a brake actuator 42 for causing the own-vehicle to generate an appropriate braking force, a throttle actuator 44 for providing an appropriate drive force to the own-vehicle, a shift actuator 46 for changing a speed of an automatic transmission of the own-vehicle, a steering actuator 48 for providing an appropriate steering angle to the own-vehicle, and a buzzer alarm 50 for performing a buzzer honking, an alarm output or a speaker output toward the interior of the vehicle compartment. As mentioned later, the ECU 40 sends an appropriate drive instruction to each of the actuators 42 to 50 based on the relative relationship between the measured present position of the own-vehicle and the target object, which is managed by the present position management part 36. Each of the actuators 42 to 50 is driven according to the drive instruction supplied from the ECU 40.

Next, a description will be given of a specific operation in the system of the present embodiment. In the present embodiment, the position-measuring part 12 first detects an initial coordinate of the own-vehicle based on an output signal of each of the receiver and the sensors 16 to 22 at each predetermined time in the estimation navigation part 24, and creates a travel path from the initial coordinate. Then, in the map-matching part 26, a first map-matching is performed for correcting a present position of the own-vehicle onto a road link thereof by collating the travel path from the initial coordinate created by the estimation navigation part 24 with link information of a road stored in the map database 30.

When the own-vehicle position is detected based on the first map-matching, the map-matching part 26 reads from the map database 30 planimetric feature data in a road range (all lanes if there are a plurality of lanes) to a position where the own-vehicle travels hereafter for a predetermined time period or predetermined distance from the own-vehicle position or to a position of a target object, which is a control object of the assist control. It should be noted that the reason for reading the planimetric feature within the predetermined road range ahead of the present position in a traveling direction is that there is a possibility that the present position of the own-vehicle measured and detected by the map-matching is not accurate. Then, a part of the planimetric features mentioned later from among all planimetirc features within the predetermined road range is set as a planimetric feature to be recognized by the back camera 32, and, thereafter, it is determined whether or not the set planimetric feature to be recognized should be requested to the external-world recognition part 34 by determining whether or not the own-vehicle position reaches near the position of the planimetric feature to be recognized based on the position of the set planimetric feature to be recognized and the own-vehicle position which is continuously updated.

The map-matching part 26 does not perform any processing if the planimetric feature to be recognized should not be requested upon the result of the above-mentioned determination, on the other hand, if the planimetric feature to be recognized should be requested, it requests the external-world recognition part 34 to take an image behind the vehicle by the back camera 32 to recognize the planimetric feature to be recognized and, simultaneously, sends feature data such as configuration data of the planimetric feature or position data and configuration data of a traveling lane. Then, after the request of the recognition to the external-world recognition part 34, it performs the above-mentioned recognition request repeatedly until a notification that the planimetric feature, which is estimated to be in a predetermined road range from the own-vehicle position, was recognized is sent from the external-world recognition part 34 in response to the recognition request or until the own-vehicle goes out of the predetermined road range.

When the external-world recognition part 34 receives from the map-matching part 26 the request for image recognition by the back camera 32, the external-world recognition part 34 performs image processing such as an edge extraction on the image taken by the back camera 32 and, then, compares the result of the image processing and the feature data of the planimetric feature sent from the map-matching part 26 so as to determine whether the planimetric feature to be recognized was recognized by the image processing.

As a result, if the planimetric feature concerned is not recognized, it sends to the map-matching part 26 information indicating that the planimetric feature to be recognized is not recognized. On the other hand, if the planimetric feature to be recognized is recognized, it sends to the map-matching part 26 information that the planimetric feature to be recognized was recognized, and sends information about a relative position and a distance between the own-vehicle and the recognized planimetric feature specified by the image processing.

Upon receipt from the external-world recognition part 34 of the notification that the planimetric feature to be recognized was recognized in the image behind the vehicle after the recognition request, the map matching part 26 measures a distance from the own-vehicle to the recognized planimetric feature present behind on the road and a relative position thereof, and performs a second map-matching for correcting the present position of the own-vehicle to a position having the relative position relationship with the position of the recognized planimetric feature based on the measured relative positions of the own-vehicle and the recognized planimetric feature and position data of the recognized planimetric feature read from the map database 30.

After performing the above-mentioned second map-matching, the map-matching part 26 accesses the map database 30 so as to acquire a distance along road traveling from the recognized object to the target object, which is an object for the assist control and, then, computes an initial value of a following remaining distance from the own-vehicle to the target object based on the position of the own-vehicle and the distance from the recognized object to the target object according to the second mat-matching.

Additionally, when the external-world recognition part 34 recognized the planimetric feature to be recognized present within the predetermined road range, the external-world recognition part 34 performs image processing on the taken image from the back camera 32 so as to acquire and recognize information of a traveling lane on the road specified by the image processing and send information containing a relative relationship of the traveling lane to the own-vehicle to the map-matching part 26. Upon receipt of the information of the traveling lane from the external-world recognition part 34, the map-matching part 26 accesses the map database 30 to acquire a lane width of the traveling lane, a number of lanes, and configuration thereof near the own-vehicle position. Then, it specifies a position of the own-lane on the road where the own-vehicle is traveling at the present time based on the information of the traveling lane sent from the external-world recognition part 34 (especially, the relative relationship with the own-vehicle) and the information regarding a number of lanes acquired from the map database 30. Although the target object may be different for each traveling lane, if the position of the own-lane is specified as mentioned above, the target object ahead on the road in a traveling direction and to be passed by the own-vehicle is identified specifically.

The estimation navigation part 24 creates an estimated path of the own-vehicle position at every predetermined time using the GPS receiver 16 and various sensors 18 to 22, and sends the path information to the map-matching part 26. After performing the second map-matching associated with the planimetric feature recognition as mentioned above, the map-matching part 26 first computes the position of the own-vehicle (especially, a distance in front and behind) relative to the recognized planimetric feature coordinate on a center line of the own-lane based on the estimated path from the time of the second map-matching and the position of the own-lane. Then, it computes the following remaining distance from the present position of the own-vehicle to the target object based on the distance ahead and behind and the distance between the above-mentioned recognized planimetric feature and the target object on the own-lane.

The information of the own-vehicle position measured and detected by the position-measuring part 12 and the information of the following remaining distance computed are output and supplied to the present position management part 36 by adding time information. Upon receipt of the information of the own-vehicle position and the following remaining distance from the map-matching part 26, the present position management part 36 detects the own-vehicle position and the following remaining distance and sends information of the present position coordinate to the navigation apparatus so that the own-vehicle position is superimposed and displayed on a road map on the display, and also sends information of the distance to the target object and time to the ECU 40 of the assist control part 14.

The ECU 40 determines whether or not a control start condition determined for each assist control is established based on the present position of the own-vehicle supplied from the position-measuring part 12 and a distance or time to the target object, which is a control object of an assist control such as a stop line, an intersection, etc. Then, it starts the assist control when the control start condition is established.

For example, in the stop control, the own-vehicle is stopped at the stop line by starting automatic braking by a brake actuator 42 at a time when a distance from the measured own-vehicle to the stop line which is a target object becomes, for example, 30 meters. It should be noted that, at this time, before starting the automatic braking by the brake actuator 42, a voice guide or the like may by performed to notify a driver of the automatic braking being carried out. Additionally, in a route guide control by voice sound, a guidance is performed to notify the driver of the fact that the target object is present ahead via a speaker output by the buzzer alarm 50 at a time when the distance from the measured own-vehicle to the target object such as an intersection or the line becomes, for example, 100 meters.

Thus, according to such a system, the assist control can be performed in response to the position of the own-vehicle measured by the position-measuring part 12, specifically, a distance to the target object. That is, the assist control is not performed before the own-vehicle reaches a predetermined relative position relationship to the target object according to the position-measurement, but, after reached, the control assist can be performed.

In the meantime, planimetric features drawn on a road surface are a stop line and a crosswalk, an arrow, a no U-turn, a diamond-shaped indication, a character string, speed-down zone, etc. Here, an accuracy error in positioning the own-vehicle position is minimized at each time when the correction (the second map-matching) associated with planimetric feature recognition by the processing the camera-taking image, and becomes larger as a travel distance of the vehicle after the correction increases during the interval due to accumulation of various detection parameter errors. Accordingly, when the vehicle travels, if all of the planimetric features appearing sequentially on the road surface are recognized from the camera-taking image at each time, the own-vehicle position is corrected relatively frequently based on the recognition result of the recognized planimetric features, and, thus, an accuracy of the own-vehicle position measured can be maintained always at a high level and even an assist control requiring a high accuracy of own-vehicle position can be performed appropriately.

However, because many planimetric features may be provided per unit distance on a road, it may happen a situation where a process load increases according to the method of recognizing the planimetric features appearing sequentially during travel of the vehicle at each time as mentioned above.

Generally, there are a plurality of kinds of planimetric features corresponding to target objects which can be an object for an assist control, such as, for example, a large-scale intersection (hereinafter, referred to as an area A) where many lanes are provided and roads cross intricately, an urban intersection (hereinafter, referred to as an area B) where national roads or prefectural roads having more than two lanes cross, a curved road of a small radius of curvature and opposite traffic of a single lane on each side and a curved road of a tollway, an exit ramp (hereinafter, referred to as an area C) of a tollway. For example, in a process of a vehicle traveling toward the above-mentioned area A, there is a high tendency that planimetric features appear along a road in an order of an arrow→a character string→a stop line→a crosswalk→an intersection.

Accordingly, upon previously storing information representing kinds (for example, the above-mentioned area A to C) of roads that can be objects of an assist control for each roads and information of arrangement patterns of the above-mentioned planimetric features having a high-possibility of appearance, after detecting a kind of the road where the own-vehicle will travel hereafter, if an arrangement pattern of planimetric features corresponding to the kind of the road where the own-vehicle will travel hereafter is read from the map database 30 and the planimetric feature to be recognized for the own-vehicle position correction is set by referring to the arrangement pattern, the planimetric feature to be recognized for the own-vehicle position correction is limited to a part and thereby reducing a process load of the planimetirc feature recognition.

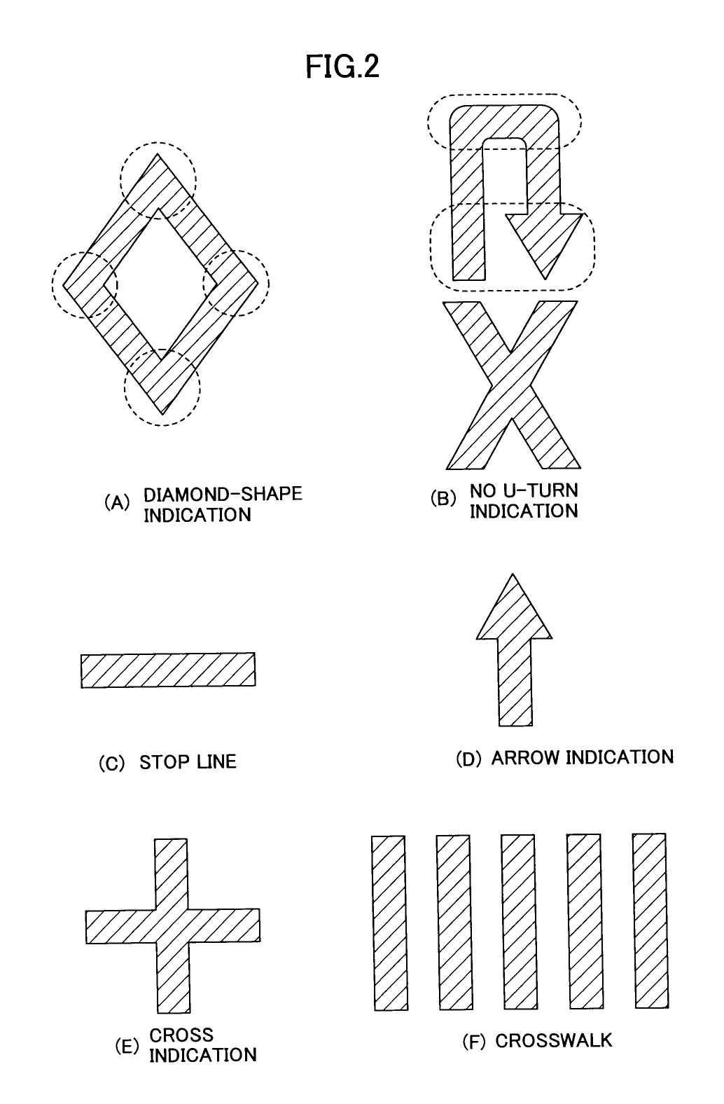

Additionally, there are many kinds of planimetric features having different feature amounts with respect to a configuration, such as, for example from a diamond-shaped indication (FIG. 2-(A); the feature part is especially portions surrounded by dashed lines) indicating an existence of a crosswalk having a configuration which can be easily extracted from a camera-taking image or a no U-turn (FIG. 2-(B); the feature part is especially portions surrounded by dashed lines) to, for example, a stop line (FIG. 2-(C)) having a configuration which is hardly extracted from a camera-taking image. Accordingly, upon previously storing the information representing a feature amount for each kind of planimetric feature of which position information or the like is stored in the map database 30 of the position-measuring part 12, and if a planimetric feature which has a large feature amount of a configuration and the feature thereof tends to appear is set as the planimetric feature to be recognized, the planimetirc feature recognition can be performed relatively easily, thereby reducing a process load of the planimetric feature recognition.

Further, there are various planimetric features such as from one having a road surface indication which tends to be scraped to one having a road surface indication which is hardly scraped, and there are a plurality of kinds having different levels of tendency of being scraped. Accordingly, upon previously storing information indicating the levels of tendency of being scraped for each kind of planimetric features of which position information or the like is stored in the map database 30 of the position-measuring 12, if a planimetric feature that tends to be scraped is set as the planimetric feature to be recognized, there is less possibility that the planimetric feature to be recognized is not recognized, thereby reducing a process load of the planimetric feature recognition.

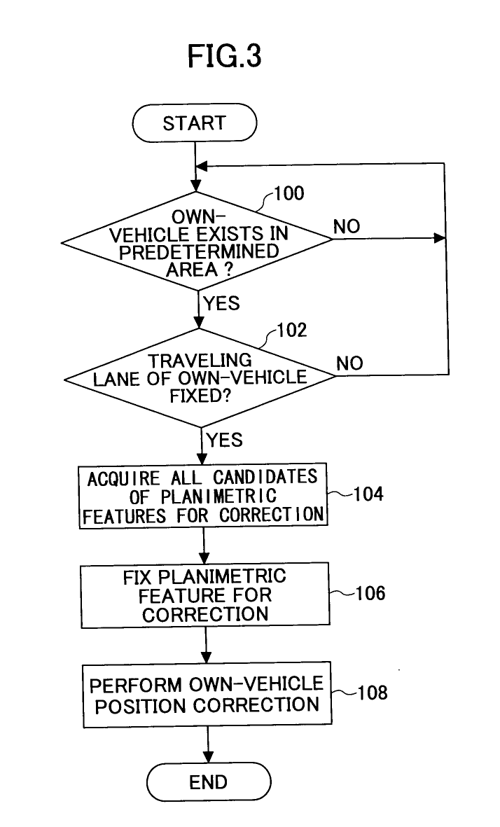

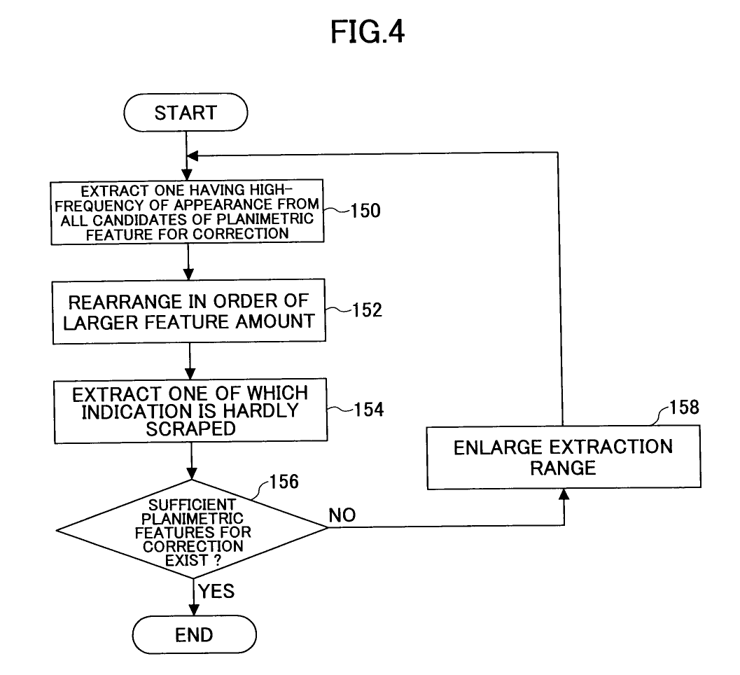

FIG. 3 shows a flowchart of an example of a main routine, which the position-measuring part 12 performs in the system of the present embodiment so as to achieve the above-mentioned function. Additionally, FIG. 4 shows a flowchart of an example of a subroutine, which the position-measuring part 12 performs in the system of the present embodiment so as to achieve the above-mentioned function. The routine shown in FIG. 4 is a routine, which is started to fix the planimetric feature to be recognized for correcting the own-vehicle position (especially, a position in an anteroposterior direction).

In the present embodiment, if the measured own-vehicle position has a certain level of accuracy due to that a level indicating an accuracy of the present position of the own-vehicle obtained as a result of map-matching is equal to or greater than a reference value, it is determined whether or not the own-vehicle exists within a predetermined area short of the target object, which is a control object of the assist control, based on the result of position measurement of the own-vehicle, specifically, the position-measured own-vehicle position and the roadmap data stored in the database 30 (step 100). This determination is performed repeatedly until an affirmative determination is made. It should be noted that as the above-mentioned predetermined area, for example, there are an area a predetermined distance short of a large-scale intersection, which is the area A, an area a predetermined before a highway exit, which is the area C, an area a predetermined short of a mountain road corner, which is the area C, etc.

If it is determined that the own-vehicle exists in the predetermined area as a result of the determination in the above-mentioned step 100, then, it is determined whether or not the position of the traveling lane on which the own-vehicle is actually traveling in the presently existing road link has been fixed (step 102). Then, if it is determined that the traveling lane of the own-vehicle has not been fixed yet, the process of the above-mentioned step 100 is performed again. On the other hand, if it is determined that the traveling lane has been fixed, first, a process of reading and acquiring all planimetric-feature candidates on the traveling lane of the road where the own-vehicle travels hereafter until it reaches the target object, which is a control object of the assist control, positioned closest to the own-vehicle is performed (step 104), and, next, a process of fixing a planimetirc feature to be recognized necessary for correcting the own-vehicle position from among all planimetric feature candidates is performed (step 106).

Specifically, in the present embodiment, the information representing a type of the road area (for example, the above-mentioned areas A to C) for each road area where the target object, which is a control object of the assist control, exists and information representing arrangement patterns of planimetric features having a high-possibility of appearance for each road type are previously stored in the road map database 30 of the position-measuring part 12. Additionally, information representing a feature amount indicating a level of easiness of extracting a configuration (for example, a magnitude of the level and its rank order) and information representing a level of tendency of an indication being scraped (for example, a magnitude of the level and its rank order) are stored for each kind of planimetric features in the map database 30.

The map-matching part 26 detects a road type in the area where the own-vehicle exists based on the road type for each road area, where the target object exists, stored in the map database 30. Then, it reads the arrangement pattern of the planimetric features corresponding to the detected road type from the map database 30, and extracts one having a high-frequency of appearance based on the arrangement pattern from among all planimetric-feature candidates to the target object acquired as mentioned above by referring to the arrangement pattern by excluding a planimetric feature having a low-frequency of appearance (step 150).

Additionally, it rearranges the thus-extracted planimetric features having a high-frequency of appearance in an order of a larger feature amount based on a configuration and a feature amount for each planimetric-feature type stored in the map database 30 (step 152). Further, it extracts planimetric features of a type of which indication tends to be scraped in some degrees except for planimetric features of a type of which indication tends to be scraped more than a predetermined magnitude based on a degree of easiness of being scraped for each planimetric-feature type stored in the map database 30 (step 154).

Thereafter, the map matching part 26 determines whether or not the planimetric feature to be recognized for correcting the own-vehicle position can be satisfied sufficiently by the planimetric feature extracted by the process of the steps 150 to 154 from all planimetric-feature candidates on the traveling lane of the road where the own-vehicle will travel hereinafter until it reaches the target object of the assist control. Specifically, it determines whether or not the own-vehicle can be caused to reach the target object by performing the assist control while maintaining the position-measurement accuracy required by the assist control if an own-vehicle position correction is performed by recognizing the planimetric feature extracted by the process of the steps 150 to 154 based on a relative relationship between the extracted planimetric features and a relative relationship between the extracted planimetric feature and the target object of the assist control (step 156).

As a result, if it is determined that the planimetric feature to be recognized for the own-vehicle position correction is not satisfied sufficiently, next, it enlarges the extraction range so that a number of extractions in the above-mentioned steps 150 to 154 is increased (step 158). For example, it widens a reference range of frequency of appearance (for example, decrease the threshold value) so that a planimetric feature, which is not included in the arrangement pattern of planimetric features having a high-possibility of appearance but has a possibility of appearance subsequently, is extracted in response to the detected road type which is initially set previously. Additionally, it changes the threshold value of a degree of easiness of indication being scraped from one initially set previously to easier one.

On the other hand, if it is determined that the planimetric feature to be recognized for own-vehicle position correction is satisfied sufficiently, the extracted planimetric feature (specifically, a planimetric feature having a relatively high-frequency of appearance and a large amount of feature amount, and an indication scrape hardly occurs) is set as the planimetric feature to be recognized necessary for correcting the own-vehicle position from among all planimetric-feature candidates on the road reaching the target object.

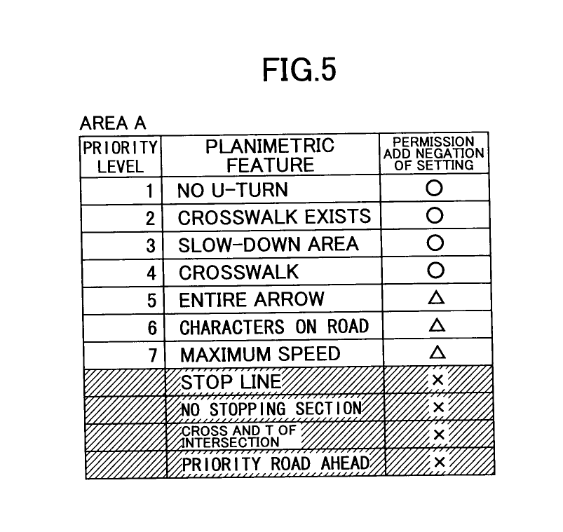

FIG. 5 shows a table representing an example of priority levels of planimetric features and permission and negation of setting thereof when setting a planimetric feature to be recognized necessary for correcting the own-vehicle position in a specific area (specifically, the area A). It should be noted that in the setting permission and negation column, a mark ◯ indicates one of which setting as a planimetric feature to be recognized is permitted, a mark Δ indicates one of which setting is permitted with conditions (for example, one existing alone without existing consecutively a plural number), and a mark X indicates one of which setting is prohibited.

That is, the map-matching part 26 sets planimetric features to which the mark ◯ is given such as shown in FIG. 5 in an area, which is the detected road type as planimetric features to be recognized necessary for own-vehicle position correction one by one in an order of higher priority level, and, thereafter, sets planimetric features of a type having a next higher priority level as the planimetric features to be recognized if only the planimetric features to be recognized are not sufficient for appropriately performing the assist control. Additionally, when a previously determined condition is established for the planimetric features to which the mark Δ is given in the area concerned, the planimetric features of such a type are made to be an object to be set. It should be noted that all of the planimetric features to which the mark ◯ is given may be set as planimetric features to be recognized at once at the time of initial setting.

If a planimetric feature to be recognized necessary for correcting the own-vehicle position, thereafter, the map-matching part 26 determines whether or not the own-vehicle position reached a vicinity of the position of the planimetric feature to be recognized based on the position of the set planimetric feature to be recognized and the position of the own-vehicle continuously updated in a road following order for the set planimetric features to be recognized, and determines whether or not to request the external-world recognition part 34 to recognize the set planimetric feature to be recognized, and, then, perform the correction of the own-vehicle position in accordance with the planimetric feature recognition based on the camera-taking image (step 108).

As mentioned above, in the present embodiment, a type of road (areas A to C) where the own-vehicle will travels hereafter is detected and a planimetric feature of a type having a high-frequency of appearance corresponding to an arrangement pattern of the detected road type can be set as the planimetric feature to be recognized necessary for the own-vehicle position correction. Additionally, in consideration of an amount of configuration feature amount for each type of planimetric features, a planimetric feature of a type having a feature which tends to appear easier can be set more as the planimetric feature to be recognized necessary for the own-vehicle position correction. Further, in consideration of a degree of easiness of indication being scraped for each type of planimetric features, a planimetric feature of a type of which road indication is more hardly scraped can be set more as the planimetric feature to be recognized necessary for the own-vehicle position correction.

That is, only characteristic planimetric features can be set as the objective planimetric feature for the own-vehicle position correction from among all planimetric features on the traveling lane of the road where the own-vehicle will travel hereafter to the target object of the assist control, and the planimetric feature to be recognized for the own-vehicle position correction can be limited to a part of the all planimetric features from the camera-taking image. For example, it can be limited to a planimetric feature of a type which has a high-frequency of appearance corresponding to road types, it can be limited to a planimetric feature of a type of which configuration feature tends to appear when processing a camera-taking image, and it can be limited to a planimetric feature of a type of which road indication is hardly scraped. Then, the second map-matching for correcting the own-vehicle position can be performed by recognizing the thus-set planimetric feature when the own-vehicle passes by.

In this regards, according to the system of the present embodiment, a number of times of performing the planimetric feature recognition and a number of times of performing the own-vehicle position correction can be reduced as compared to a system which performs an own-vehicle position correction, by recognizing all planimetric features on a road where the own-vehicle will travel hereafter to target object by processing an image taken by the back camera 32 at each time, for each recognition of the all planimetric features, and, thereby, a process load for performing the planimetric feature recognition and the own-vehicle position correction can be reduced.

It should be noted that in the present embodiment, even under the situation where a planimetric feature to be recognized for own-vehicle position correction as mentioned above, the limitation, that is, the correction of an own-vehicle position is performed in a range (a timing) where a position measurement accuracy that is required for appropriately performing an executable assist control. Thus, according to the system of the present embodiment, a process load of the planimetric feature recognition can be reduced while maintaining the accuracy of an own-vehicle position at a certain high accuracy, that is, while causing the assist control corresponding to the own-vehicle position to be executable, and a process load of an own-vehicle position correction based on a recognized planimetric feature control can be reduced.

It should be noted that, in the above-mentioned embodiment, the position-measuring part 12 corresponds to the “own-vehicle position measuring apparatus” recited in the claims, the back camera 32 corresponds to the “image-taking means” recited in the claims, and the position measurement of an own-vehicle position using both a GPS and a travel path of the own-vehicle corresponds to the “predetermined method” recited in the claims, respectively. Additionally, the “planimetric feature recognizing means” recited in the claims is realized by the external-world recognition part 34 recognizing a planimetric feature necessary for the own-vehicle position correction from an image taken by the back camera 32 according to a request from the map-matching part 26, the “position correcting means” recited in the claims is realized by the map-matching part 26 performing a map-matching to correct an own-vehicle position to a position based on a recognized planimetric feature, and the “planimetric feature setting means” recited in the claims can be realized by the map-matching part 26 performing the above-mentioned process of step 106 shown in FIG. 3, that is, the routine shown in FIG. 4, respectively.

In the meantime, in the above-mentioned embodiment, although after extracting planimetric features having a high frequency of appearance from among all planimetric features on a road where the own-vehicle will travel hereafter to a target object, the extracted planimetric features are rearranged in an order of a more feature amount, which enables a planimetric feature of a type having a relatively small feature amount to be set as the planimetric feature to be recognized for the own-vehicle position correction, it is possible that only a planimetric feature having a feature amount more than a predetermined amount can be set as the planimetric feature to be recognized for the own-vehicle position correction.

Additionally, in this case, a threshold value of the feature amount may be changed previously from an initially set one to a smaller one so that, if planimetric features to be recognized for the own-vehicle position correction are not satisfied sufficiently, the number of the planimetric features is increased.

Additionally, in the above-mentioned embodiment, although as a characteristic planimetric feature to be set as a planimetric feature to be recognized for the own-vehicle position correction from among all planimetric features on a road where the own-vehicle will travel hereafter to a target object, a planimetric feature having a high-frequency of appearance, a planimetric feature having a characteristic that can be easily extracted from a camera-taking image with respect to a configuration, and a planimetric feature in which indication scraping hardly occurs are used, the present invention is not limited to this, and, for example, a planimetric feature existing ahead by more than a predetermined distance may be set as a planimetric feature to be recognized for the own-vehicle from among planimetric features existing ahead of and behind the own-vehicle. If a distance between two planimetric features is relatively long, a situation in which other planimetric features are erroneously recognized hardly occurs in recognizing any one of the planimetric features from a camera-taking image, and a situation in which the position thereof is erroneously recognized hardly occurs. Thus, in such a variation, the same effects as the above-mentioned embodiment can be obtained.

Additionally, in the above-mentioned embodiment, although a characteristic planimetric feature is set as a planimetric feature to be recognized for the own-vehicle position correction from among all planimetric features on a road to a target object which the own vehicle will reach hereafter, a correction in an anteroposterior direction along a road traveling lane and a correction in a left and right direction perpendicular to a road traveling lane may be separated and independently performed from each other with respect to the recognized planimetric feature setting for own-vehicle position correction. There is a case in which a type of a planimetric feature which is effective in performing the correction of an own-vehicle position in an anteroposterior direction and a type of a planimetric feature which is effective in performing the correction in a left and right direction. Accordingly, by distinguishing the anteroposterior direction correction and the left and right direction correction so as to perform the recognized planimetric feature setting for the own-vehicle position correction, an attempt can be made to make it more efficient and to reduce a process load in performing the own-vehicle position correction.

Additionally, in the above-mentioned embodiment, although a recognition of a planimetric feature is performed using the back camera 32 provided on a rear part of the vehicle so as to perform the second map-matching for correcting an own-vehicle position based on the recognized planimetric feature, the recognition of the planimetric feature in performing the second map-matching may be performed based on an image taken by a camera provided on a front part of the vehicle or information sent from an external infrastructure.

Additionally, in the above-mentioned embodiment, although an own-vehicle position is position-measured using both a GPS and a travel path of the own-vehicle in the estimation navigation part 24, it is applicable to a system for position-measuring an own-vehicle position using only either one of those.

Additionally, in the above-mentioned embodiment, although the map database 30 is equipped in a vehicle, it may be provided to a center so that data stored in the map database can be read by the vehicle accessing it at each time.

Further, in the above-mentioned embodiment, although the stop control, the intersection control, the speed control and the guidance control are mentioned as the assist control, it is applicable to a system for performing other controls to be performed in response to a position of the own-vehicle.

It should be noted that the present international application claims a priority based on Japanese Patent Application No, 2006-148683 filed May 29, 2006, the entire contents of which are hereby incorporated herein by reference.

1. An own-vehicle position measuring apparatus comprising:
planimetric feature recognizing means for recognizing a planimetric feature on a road that is necessary for correcting an own-vehicle position; and
position correcting means for correcting the own-vehicle position detected according to a predetermined method based on a recognition result by said planimetric feature recognizing means,
the own-vehicle position measuring apparatus further comprising recognizing planimetric feature setting means for setting a planimetric feature characteristic in an area where the own-vehicle will travel hereafter from among planimetric features on the road of which information is stored in a database,
wherein said planimetric feature recognizing means recognizes said planimetric feature set by said recognizing planimetric feature setting means.

2. The own-vehicle position measuring apparatus as claimed in claim 1, wherein said recognizing planimetric feature setting means sets a planimetric feature, which is estimated to appear in the area where the own-vehicle will travel hereafter by referring to a predetermined arrangement pattern of the planimetric feature according to a kind of a road on which the own-vehicle will travel hereafter, as said planimetric feature to be recognized by said planimetric feature recognizing means.

3. The own-vehicle position measuring apparatus as claimed in claim 1 or 2, wherein said recognizing planimetric feature setting means sets a planimetric feature of a kind in which a characteristic thereof tends to appear in the area where the own-vehicle will travel hereafter as said planimetric feature to be recognized by said planimetric feature recognizing means.

4. The own-vehicle position measuring apparatus as claimed in one of claims 1 to 3, wherein said recognizing planimetric feature setting means sets a planimetric feature of a kind in which a road-surface sign is hardly scraped in the area where the own-vehicle will travel hereafter as said planimetric feature to be recognized by said planimetric feature recognizing means.

5. The own-vehicle position measuring apparatus as claimed in one of claims 1 to 4, wherein said recognizing planimetric feature setting means sets a planimetric feature having a distance from a planimetric feature positioned ahead or behind longer than a predetermined distance in the area where the own-vehicle will travel hereafter as said planimetric feature to be recognized by said planimetric feature recognizing means.

6. The own-vehicle position measuring apparatus as claimed in one of claims 1 to 5, wherein said planimetric feature recognizing means recognizes a planimetric feature on the road based on an image taken by image-taking means for taking images around a vehicle.

7. The own-vehicle position measuring apparatus as claimed in one of claims 1 to 6, wherein said predetermined method is a method of detecting an own-vehicle position by using a GPS or a travel path of the own-vehicle.
